(19) United States
(12) Patent Application Publication
(10) Pub. No.: US 2022/0392010 A1
(43) Pub. Date: Dec. 8, 2022

(54) VEHICLE DISPATCH DEVICE, CONTROL METHOD, AND CONTROL PROGRAM

(71) Applicant: TOYOTA BOSHOKU KABUSHIKI KAISHA, Aichi-ken (JP)

(72) Inventors: Yasuhiro ISHIGURO, Aichi (JP); Yuki KAMIYA, Aichi (JP); Osamu KAWASE, Aichi (JP)

(73) Assignee: TOYOTA BOSHOKU KABUSHIKI KAISHA, Aichi-ken (JP)

(21) Appl. No.: 17/830,049

(22) Filed: Jun. 1, 2022

(30) Foreign Application Priority Data
Jun. 3, 2021 (JP) 2021-093891

(51) Int. Cl. G06Q 50/30; G06Q 10/06

(52) U.S. Cl. CPC G06Q 50/30; G06Q 10/063114

(57) ABSTRACT

A vehicle dispatch device includes: a demand information obtaining section configured to obtain a demand spot at which demand for vehicle dispatch is expected and demand time at which the demand is expected; a biological condition obtaining section configured to obtain, for each of drivers, a change over time of a biological condition from the present to the demand time; and a vehicle dispatch supporting section configured to determine, for each of the drivers, a required rest time necessary for taking a rest in order to make a level of the biological condition less than a predetermined threshold value at the demand time in the change over time, and to identify, from among the drivers, one or more drivers who are capable of finishing both of traveling to the demand spot and taking the rest by the demand time.

This Nonprovisional application claims priority under 35 U.S.C. § 119 on Patent Application No. 2021-093891 filed in Japan on Jun. 3, 2021, the entire contents of which are hereby incorporated by reference.

### TECHNICAL FIELD

The present invention relates to a vehicle dispatch device for arranging drivers in human transportation services.

### BACKGROUND ART

Patent Literature 1 discloses a vehicle dispatch support system for appropriately dispatching taxicabs on the basis of demand prediction information on predicted taxicab users. The demand prediction information is obtained from vacant vehicle information, sales volume, taxicab location information, and the like.

Patent Literature 2 discloses a degree-of-trouble calculation system which calculates a degree of trouble with respect to driver's safe driving, and which in accordance with the degree of trouble, gives advice to that driver and proposes taking a rest.

### CITATION LIST

### Patent Literature

[Patent Literature 1]
Japanese Patent Application Publication Tokukai No. 2019-91274

[Patent Literature 2]
Japanese Patent Application Publication Tokukai No. 2020-64553

### Non-Patent Literature

[Non-Patent Literature 1]
C. Jacobe de Naurois et al., “Detection and prediction of driver drowsiness using artificial neural network models”, Accident Analysis and Prevention 126, pp. 95-104, 2019

[Non-Patent Literature 2]
Ajjen Joshi et al., “In-the-wild Drowsiness Detection from Facial Expressions”, Oct. 21, 2020

### SUMMARY OF INVENTION

### Technical Problem

However, in the system disclosed in Patent Literature 1, although vehicle dispatch in consideration of demand is possible, drive's load is not taken into consideration. This may impair safety. On the other hand, in the system disclosed in Patent Literature 2, although taking a rest is proposed from the viewpoint of safety, demand cannot be taken into consideration. This may impair efficiency (e.g., revenue).

An object of an aspect of the present invention is to realize a vehicle dispatch device capable of ensuring both of safety and efficiency at the same time.

### Solution to Problem

In order to solve the above problems, a vehicle dispatch device in accordance with an aspect of the present invention includes: a demand information obtaining section configured to obtain a demand spot at which demand for vehicle dispatch is expected and demand time at which the demand is expected; a biological condition obtaining section configured to obtain, for each of drivers, a change over time of a biological condition from the present to the demand time; and a vehicle dispatch supporting section configured to determine, for each of the drivers, a required rest time necessary for taking a rest in order to make a level of the biological condition less than a predetermined threshold value at the demand time in the change over time, and to identify, from among the drivers, one or more drivers who are capable of finishing both of traveling to the demand spot and taking the rest by the demand time.

In order to solve the above problems, a method for controlling a vehicle dispatch device in accordance with an aspect of the present invention includes: a demand information obtaining step of obtaining a demand spot at which demand for vehicle dispatch is expected and demand time at which the demand is expected; a biological condition obtaining step of obtaining, for each of drivers, a change over time of a biological condition from the present to the demand time; and a vehicle dispatch supporting step of determining, for each of the drivers, a required rest time necessary for taking a rest in order to make a level of the biological condition less than a predetermined threshold value at the demand time in the change over time, and to identify, from among the drivers, one or more drivers who are capable of finishing both of traveling to the demand spot and taking the rest by the demand time.

A vehicle dispatch device in accordance with each aspect of the present invention can be realized by a computer. The computer is operated on the basis of (i) a vehicle dispatch device control program for causing the computer to realize the vehicle dispatch device by causing the computer to operate as each section (software element) included in the vehicle dispatch device and (ii) a computer-readable storage medium in which the vehicle dispatch device control program is stored. Such a control program and a computer-readable storage medium are included in the scope of the present invention.

### Advantageous Effects of Invention

An aspect of the present invention makes it possible to realize a vehicle dispatch device capable of ensuring both of safety and efficiency at the same time.

### BRIEF DESCRIPTION OF DRAWINGS

FIG. 1 is a block diagram illustrating a configuration of a vehicle dispatch system in accordance with Embodiment 1 of the present disclosure.

FIG. 2 is a diagram illustrating an example of a data structure of demand information.

FIG. 3 is a graph showing an example of change-over-time information on an unsuitability level.

FIG. 4 is a chart illustrating an example of a data structure of an availability table.

FIG. 5 is a chart illustrating an example of a data structure of vehicle dispatch result information.

FIG. 6 is a flow chart showing a flow of a process which is carried out by the vehicle dispatch device.

FIG. 7 is a flow chart showing a flow of an availability-for-vehicle-dispatch determination process which is carried out by the vehicle dispatch supporting section.

FIG. 8 is a diagram illustrating an example of a notification which is outputted from an information outputting section of an in-vehicle system.

FIG. 9 is a block diagram illustrating a configuration of a vehicle dispatch system in accordance with Embodiment 2 of the present disclosure.

FIG. 10 is a diagram illustrating an example of a result screen which is displayed on a display section of a user terminal device.

### DESCRIPTION OF EMBODIMENTS

### Embodiment 1

<Overview of Vehicle Dispatch System>

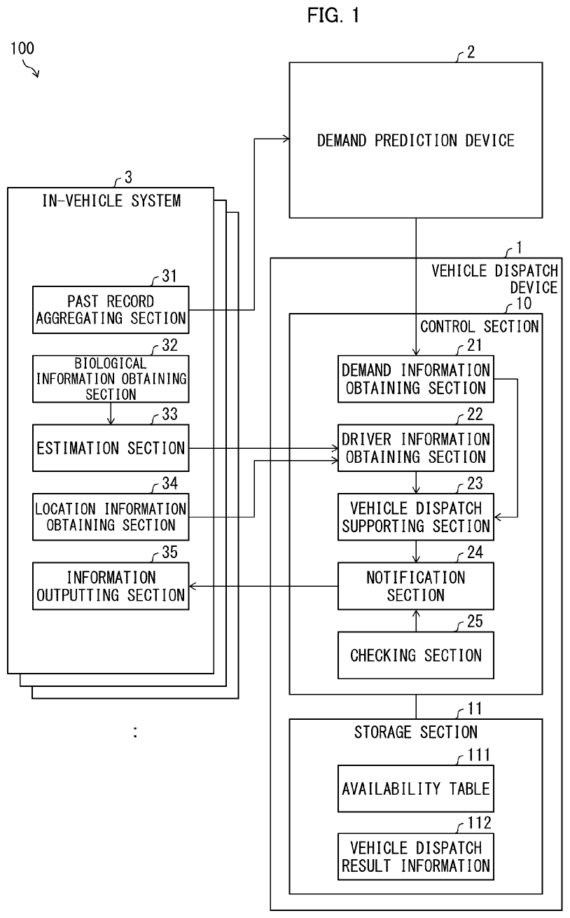

FIG. 1 is a block diagram illustrating a configuration of a vehicle dispatch system 100. FIG. 1 also shows respective configurations of main parts of a vehicle dispatch device 1 and an in-vehicle system 3, which are included in the vehicle dispatch system 100. In Embodiment 1, the vehicle dispatch system 100 is, for example, a system for managing taxicabs (hereinafter, vehicles) in a taxicab company.

The vehicle dispatch system 100 includes the vehicle dispatch device 1 which manages and dispatches a plurality of vehicles, the in-vehicle system 3 which is mounted on each one of the plurality of vehicles that are managed by the vehicle dispatch device 1, and a demand prediction device 2 which predicts demand for vehicle dispatch. The demand prediction device 2 may be incorporated as a part of the vehicle dispatch device 1.

In the vehicle dispatch system 100, the vehicle dispatch device 1 communicates with the in-vehicle system 3 which is mounted on each of the vehicles driven by respective drivers who are working for the taxicab company, and manages each of the vehicles, that is, each of the drivers. If needed, the vehicle dispatch device 1 can make a determination to allocate one of the vehicles to a desired location, i.e., dispatch the vehicle, and can instruct the driver of the vehicle thus allocated to go to the location described above.

Note that, in Embodiment 1, it is assumed that one vehicle corresponds to one driver. Hereinafter, expressions such as “dispatch a driver (to a location)”, “arrange a driver (to a location)”, and “assign a driver (to a location)” all mean “(the vehicle dispatch device 1) allocates a vehicle (to a location)”, i.e., dispatch a vehicle”.

Note that in the vehicle dispatch system of the present disclosure, the subject of vehicle dispatch is not limited to a vehicle. The vehicle dispatch system of the present disclosure can be utilized for dispatch of any transportation means which is used for transportation in transportation services that can be used by customers by selecting departure times, departure and arrival locations, and the like.

(Configuration of In-Vehicle System)

One in-vehicle system 3 is mounted on one vehicle. The in-vehicle system 3 transmits and receives necessary information to/from the vehicle dispatch device 1. Specifically, the in-vehicle system 3 transmits, to the vehicle dispatch device 1, information on the vehicle and a driver who drives the vehicle. The in-vehicle system 3 receives notification from the vehicle dispatch device 1, and conveys the content of the notification to the driver.

The in-vehicle system 3 includes, for example, a past record aggregating section 31, a biological information obtaining section 32, an estimation section 33, a location information obtaining section 34, and an information outputting section 35.

The past record aggregating section 31 aggregates past records of the driver. The past record aggregating section 31 may be configured to include, for example, a taximeter. The past record aggregating section 31 obtains and stores, as performance information, the status (occupied, pickup, vacant, out of service, payment, etc.), travel distance, travel speed, travel time, sales, etc. of the vehicle. The performance information which has been aggregated by the past record aggregating section 31 is transmitted to the demand prediction device 2 or the vehicle dispatch device 1 via a communication device (not shown) of the in-vehicle system 3.

The biological information obtaining section 32 obtains biological information on the driver. The biological information obtaining section 32 may be configured to include, for example, various measuring devices for observing, measuring, or detecting a condition of the driver. The biological information obtaining section 32 includes, as measuring devices, for example, a camera for taking an image of a state of the driver, a heartbeat sensor for measuring the heart rate of the driver, and a respiration sensor for measuring the breathing rate of the driver. The measuring devices are not limited to those described above. The measuring device may be any measuring device provided that the measuring device can obtain biological information from which an unsuitability level (level of a biological condition) can be derived as an index value, the unsuitability level indicating a degree of impairment of driver's health suitable for driving

The unsuitability level refers to a degree of an unhealthy condition unsuitable for driving, as described above. The unhealthy condition refers to a condition that can be restored by taking a rest for, for example, sleeping, reposing, or having a meal. The unsuitability level may indicate, for example, a degree of drowsiness, fatigue, or impaired concentration. In Embodiment 1, the higher value of the unsuitability level indicates a higher degree of an unhealthy condition unsuitable for driving. It is possible to lower the unsuitability level by taking a rest.

In Embodiment 1, the unsuitability level is, for example, a drowsiness level (level of the biological condition) that indicates a degree of drowsiness of the driver. Accordingly, it is possible to employ, as the measuring devices, a camera, a heartbeat sensor, a respiration sensor, and the like, which acquire biological information usable for determining drowsiness of the driver.

The biological information obtaining section 32 obtains, as the biological information, for example, a photo or a moving image which is obtained through the camera, the heart rate which is obtained through the heartbeat sensor, the breathing rate which is obtained through the respiration sensor, and the like. The biological information which has been obtained by the biological information obtaining section 32 is inputted into the estimation section 33. If needed, the biological information obtaining section 32 may input, into the estimation section 33, the biological information itself (raw data), which has been outputted from the measuring device(s), or may input, into the estimation section 33, a feature amount which has been extracted from the biological information by a predetermined procedure.

The estimation section 33 estimates the level of the biological condition of the driver, on the basis of the biological information which has been obtained by the biological information obtaining section 32. For example, the estimation section 33 may estimate, as the biological condition, the unsuitability level which indicates the degree of impairment of driver's health suitable for driving. More specifically, the estimation section 33 predicts a change of the unsuitability level in a predetermined period of time, on the basis of the biological information which has been obtained up to the time of estimation by the biological information obtaining section 32 and the unsuitability level which has been determined up to the time of estimation on the basis of the biological information. The predetermined period of time may be, for example, a predetermined period of time from a time point (e.g., the present time) at which the latest biological information is obtained. The estimation section 33 generates change-over-time information, which indicates the change of the unsuitability level, the change having been predicted. The estimation section 33 then outputs, to the vehicle dispatch device 1, the change-over-time information. The change-over-time information on the unsuitability level (change over time of the biological condition) may be, for example, a graph of the unsuitability level which has been estimated, the graph having been created by plotting the unsuitability level on the vertical axis and the time in a predetermined period of time on the horizontal axis.

The estimation section 33 may be, for example, a drowsiness estimation section which predicts a change of a drowsiness level that indicates a change of the degree of drowsiness of the driver in a predetermined period of time. That is, the unsuitability level may be the drowsiness level.

In Embodiment 1, the estimation section 33 may be, for example, realized by artificial intelligence (AI). As an example of the AI, it is possible to use, for example, an estimation model which is trained so as to output the change-over-time information on the drowsiness level which is predicted for a predetermined period of time from the present, by using, as inputs, at least one feature amount which has been extracted from the biological information on the driver and change-over-time information on past drowsiness levels.

For example, it is possible to employ a model that predicts drowsiness, the model being disclosed in Non-patent Literature 1. The model disclosed in Non-patent Literature 1 is a model of a neural network in which blinking, a ratio of eye closure time per unit time (percent of eyelid closure; PERCLOS) and the like are used as feature amounts. This model predicts, from driver's physiological and behavioral indexes, how many minutes later drowsiness of that driver reaches 1.5. “Drowsiness 1.5” corresponds to drowsiness between “slightly drowsy” and “moderately drowsy” disclosed in Non-patent Literature 2.

The change-over-time information on the driver's drowsiness level is transmitted to the vehicle dispatch device 1 via a communication device (not shown), the change-over-time information having been outputted by the estimation section 33 and being predicted as information in a predetermined period of time. The change-over-time information on the drowsiness level may be, for example, a drowsiness estimation graph which has been created by plotting the drowsiness level on the vertical axis and the time in a predetermined period of time on the horizontal axis.

The estimation section 33 may determine the condition of the driver at a time point (for example, present time) at which the biological information is obtained, on the basis of the biological information which has been obtained by the biological information obtaining section 32. The estimation section 33 may transmit, to the driver information obtaining section 22, an actual measured value which indicates a determined condition of the driver.

The location information obtaining section 34 obtains the present location of the vehicle. The location information obtaining section 34 may be configured to include, for example, a global positioning system (GPS). The location information obtaining section 34 transmits the present location which has been obtained for the vehicle, to the vehicle dispatch device 1 via a communication device (not shown) of the in-vehicle system 3.

The information outputting section 35 outputs and transmits, to the driver, information which has been processed by the in-vehicle system 3. The information outputting section 35 may be, for example, a display device for displaying visual information such as images and characters, which has been generated by the in-vehicle system 3 and/or received from the vehicle dispatch device 1. The information outputting section 35 may be an audio output device for outputting audio information such as sound, which has been generated by the in-vehicle system 3 and/or received from the vehicle dispatch device 1. The location information obtaining section 34 and the information outputting section 35 may be configured as parts of a car navigation system.

(Configuration of Demand Prediction Device)

The demand prediction device 2 predicts the demand for vehicle dispatch. In Embodiment 1, the demand prediction device 2 periodically predicts expected demand in a predetermined period of time (e.g., in a period of three hours) from the present time, on the basis of the performance information which is sent from the past record aggregating section 31 of each of the vehicles. In Embodiment 1, it is assumed by way of example that the demand prediction device 2 predicts once every three hours the demand in a predetermined period of time from the present time. However, an embodiment of the present invention is not limited to this, and for example, in prediction for a more nearby region where operations are allowed, the demand prediction device 2 may predict the demand once every hour.

As a method by which the demand prediction device 2 predicts the demand, it is possible to employ a well-known technique. The demand prediction device 2 may predict the demand by additionally taking into consideration, for example, the location information on each of the vehicles up to the present time on a day on which the demand is predicted and past performance information under conditions (season, weather, day of the week, time of the day, etc.) which are the same as those on the day on which the demand is predicted.

In Embodiment 1, the demand prediction device 2 determines, in a region in which the taxicab company can operate, an area in which a demand level is not less than a predetermined threshold value in a predetermined period of time from the present time. The demand level is an index value which indicates a degree of the demand for vehicle dispatch, and for example, may be represented by five levels. The value of the demand level is higher when there are more passengers who would like to have a ride or more sales are expected.

Hereinafter, the term “hot area” refers to an area in which in a predetermined period of time, the demand level becomes not less than the predetermined threshold value and the demand is expected to be not lower than a certain level. In Embodiment 1, for example, the demand prediction device 2 identifies, as the hot area, an area having a demand level of not less than 3 in a predetermined period of time.

The demand prediction device 2 generates demand information for each of hot areas thus identified, and outputs the demand information to the vehicle dispatch device 1. In Embodiment 1, the demand information includes, for example, a demand spot, demand time, and the number of necessary drivers. It should be noted that the demand information may include, according to need, change-over-time information on the demand level of a hot area in a predetermined period of time. The change-over-time information may be, for example, a demand prediction graph which is created by plotting the demand level on the vertical axis and the time in the predetermined period of time on the horizontal axis.

The demand spot is information for identifying a location where the demand for vehicle dispatch is expected. In Embodiment 1, the demand spot may be a representative spot of the hot area. Hereinafter, the representative spot of the hot area is referred to as “hot area spot”. Which spot in the hot area is to be used as the representative spot is not particularly limited. It is possible to employ, as the representative spot, the center of gravity or a center in a case where the hot area is taken as a two-dimensional figure. It is also possible to employ, as the representative spot, the position of a taxicab stand in the hot area. Further, it is also possible to employ, as the representative spot, a spot that is in the hot area and that is nearest to the position of each of the vehicles or each of the drivers.

The demand time is information that indicates time at which demand is expected at the demand spot described above. In Embodiment 1, the demand time may be demand peak time that indicates, for the hot area, time at which the demand is predicted to be the highest in a predetermined period of time.

The number of necessary drivers (number of drivers) is information that indicates the number of drivers that matches the demand. For example, the number of necessary drivers may be a reasonable number of drivers that can satisfy the demand in the hot area without excess or shortage. There is no particular limitation on a method of determining the number of necessary drivers. For example, the number of necessary drivers may be associated with each demand level in advance, and the demand prediction device 2 may determine the number of necessary drivers that is associated with the demand level at the demand peak time in the hot area. Alternatively, the demand prediction device 2 may calculate the number of necessary drivers in consideration of the length of hours during which the demand level is not less than 3 in a predetermined period of time, how wide the hot area is, and the like.

(Configuration of Vehicle Dispatch Device)

The vehicle dispatch system 100 includes at least one vehicle dispatch device 1, and the vehicle dispatch device 1 is provided together with the demand prediction device 2, for example, in a vehicle dispatch center of a taxicab company. The vehicle dispatch device 1 can communicate with the in-vehicle system 3 of each of the vehicles on which respective drivers ride, via a communication network through a communication device (not shown). When the demand prediction device 2 is not incorporated in the vehicle dispatch system 1, the vehicle dispatch device 1 may be connected to the demand prediction device 2 via, for example, a local area network (Local Area Network) so as to be capable of communicating with the demand prediction device 2.

The vehicle dispatch device 1 includes a control section 10, a storage section 11, and a communication device (not shown) described above. The control section 10 carries out overall control of each section of the vehicle dispatch device 1. The control section 10 is configured by, for example, a computation device such as a central processing unit (CPU) or a dedicated processor. Each section of the control section 10, which will be described later, can be realized by causing the computation device to read, into a random access memory (RAM), a program stored in a storage device (e.g., storage section 11) embodied in the form of, for example, a read only memory (ROM), and to execute the program. The storage section 11 stores various data used by the control section 10. The storage section 11 may be configured as an external storage device which is accessible to the control section 10.

In Embodiment 1, the control section 10 includes, for example, a demand information obtaining section 21, a driver information obtaining section 22 and a vehicle dispatch supporting section 23. If needed, the control section 10 may further include a notification section 24. Note that a checking section 25 will be described in detail in Variation 1 described later. In the storage section 11, for example, an availability table 111 and vehicle dispatch result information 112 are stored.

The demand information obtaining section 21 obtains at least the demand spot where demand for vehicle dispatch is expected and the demand time at which the demand is expected. In Embodiment 1, the demand information obtaining section 21 obtains the demand spot and the demand information from the demand prediction device 2. The demand information obtaining section 21 obtains, for each of the hot areas, for example, the demand information which includes the hot area spot, the demand peak time, and the number of necessary drivers.

The driver information obtaining section 22 obtains driver information for each of the drivers. For example, the driver information obtaining section 22 serves as a driver location obtaining section, and obtains the present location of the driver from the location information obtaining section 34. Further, for example, the driver information obtaining section 22 serves as a biological condition obtaining section, and obtains, for each of the drivers, a change over time of the level of the biological condition. The biological condition level may be an unsuitability level. The unsuitability level is an index which indicates the degree of impairment of driver's health suitable for driving, the index having been estimated on the basis of the biological information on the driver. The change-over-time information on the unsuitability level is information that indicates a change of the unsuitability level in a predetermined period of time which includes a period of time from the present time to the demand time. The driver information obtaining section 22 may obtain the change-over-time information for each of the drivers, from the estimation section 33 which is mounted on each of the vehicles.

Note that the biological information obtaining section 32 may include a determination section (not shown) which determines the unsuitability level of the driver at the present time on the basis of an actual measured value of the biological information that has been obtained from the driver. In this case, the driver information obtaining section may further obtain, from the biological information obtaining section 32, the unsuitability level of the driver which is determined at the present time, the unsuitability level being based on actual measurement.

The vehicle dispatch supporting section 23 supports vehicle dispatch. In other words, the vehicle dispatch supporting section 23 decides a driver(s) to be dispatched to the demand spot at the demand time. More specifically, the vehicle dispatch supporting section 23 determines, for each of the drivers, a required rest time for making the level of the biological condition at the demand time less than the predetermined threshold value in the change-over-time information. The vehicle dispatch supporting section 23 identifies a driver(s) who can finish both of traveling to the demand spot and taking the rest by the demand time. In addition, the vehicle dispatch supporting section 23 may select one or more drivers who are to be assigned or dispatched to the demand spot, from among the above-described identified drivers. As described above, the vehicle dispatch supporting section 23 can support the vehicle dispatch.

For example, the vehicle dispatch supporting section 23 identifies a driver(s) who can arrive at the demand spot by the demand time in a condition in which the unsuitability level is less than the predetermined threshold, in consideration of the required rest time necessary for the driver in order to make the unsuitability level less than the predetermined threshold value. The vehicle dispatch supporting section 23 decides to dispatch the driver(s) thus identified to the demand spot. In other words, the vehicle dispatch supporting section 23 carries out a process of assigning a driver(s) to a demand spot(s).

More specifically, in Embodiment 1, for example, the vehicle dispatch supporting section 23 carries out, for each of the hot areas, an availability-for-vehicle-dispatch determination process for determining whether or not each of the drivers can be dispatched to the hot area. Then, the vehicle dispatch supporting section 23 carries out a vehicle dispatch decision process in which selecting a driver(s) to be dispatched to the hot area is selected from among the drivers who are determined to be available for vehicle dispatch to the hot area.

The vehicle dispatch supporting section 23 determines a required rest time of the driver, on the basis of a drowsiness estimation graph of the driver, in the availability-for-vehicle-dispatch determination process. The vehicle dispatch supporting section 23 then determines, in consideration of the required rest time, whether or not the driver can arrive at the hot area spot by the demand peak time in a condition in which the drowsiness level is less than the predetermined threshold value, that is, in a condition in which the driver is awake so as to be capable of safely drive. The vehicle dispatch supporting section 23 identifies, as a driver(s) who can be dispatched to the hot area, the driver(s) who can arrive at the hot area spot by the demand peak time in the condition in which the drowsiness level is less than the predetermined threshold value.

The vehicle dispatch supporting section 23 generates the availability table 111, for each of the hot areas through the availability-for-vehicle-dispatch determination process, and stores the availability table 111 in the storage section 11. The availability table 111 is a table which indicates, for each of the drivers, whether or not the vehicle can be dispatched to the hot area.

It should be noted that for a driver(s) whose drowsiness level has never reached a level of not less than the predetermined threshold value in the drowsiness estimation graph described above, the vehicle dispatch supporting section 23 may determine that no rest is necessary and may specify the rest time as zero or alternatively may omit the process of determining the required rest time.

In the vehicle dispatch determination process, the vehicle dispatch supporting section 23 selects, for each of the hot areas, a driver(s) who is to be actually dispatched to the hot area from among the drivers who are available for vehicle dispatch. The vehicle dispatch supporting section 23 may assign drivers such that the number of the drivers corresponds to the number of necessary drivers in the hot area.

The vehicle dispatch supporting section 23 generates the vehicle dispatch result information 112 through the vehicle dispatch decision process and stores the vehicle dispatch result information 112 in the storage section 11. The vehicle dispatch result information 112 includes a driver(s) (vehicle(s)) to be dispatched, a hot area(s) which is/are a destination(s) assigned to the driver(s), and expected arrival time(s) at the hot area(s). Therefore, with reference to the vehicle dispatch result information 112, the vehicle dispatch device 1 can determine which driver(s) will be dispatched to which hot area(s) by when.

The notification section 24 provides notification of at least the demand spot and the demand time via the in-vehicle system 3 of each of the vehicles, to the driver who is assigned to the hot area (demand spot) by the vehicle dispatch supporting section 23. Specifically, the notification section 24 transmits, to the in-vehicle system 3 of the vehicle of the driver who is determined to be dispatched, a request regarding dispatch, the request including at least (i) the hot area spot of the hot area which is the destination of dispatch and (ii) the expected arrival time at the hot area.

In a case where the vehicle dispatch supporting section 23 determines that rest is necessary for the driver, the notification section 24 may transmit, to the in-vehicle system 3 of the vehicle of the driver, advice information that gives an advice on a manner of taking a rest. For example, the notification section 24 may notify the driver of a resting place. The resting place may be at a present location of the driver, or the hot area spot, or any spot on a route from the present location to the hot area spot.

<Demand Information>

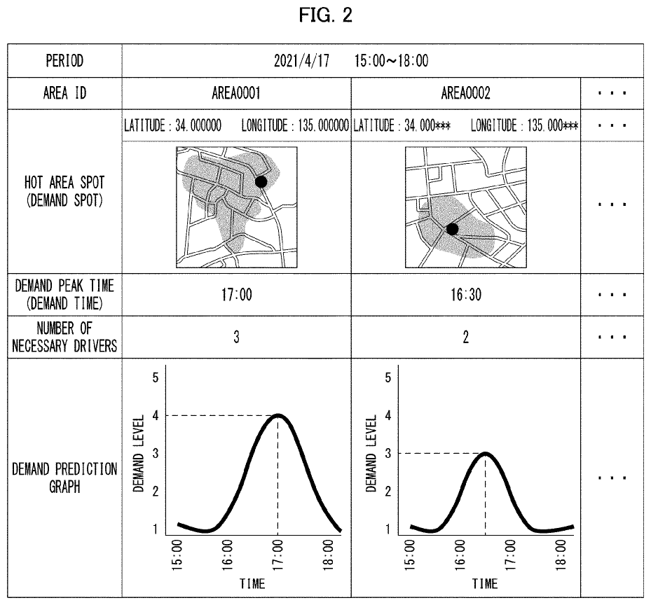

FIG. 2 is a diagram illustrating an example of a data structure of the demand information. For example, the demand prediction device 2 sets a predetermined period of time to 15:00 to 18:00 on Apr. 17, 2021 and identifies hot areas in which demand is expected to be high in the predetermined period of time, and generates demand information for each of the hot areas. The demand prediction device 2 generates demand information for each of these hot areas. FIG. 2 shows the demand information for each of the hot areas in the predetermined period of time “15:00 to 18:00 on Apr. 17, 2021”. FIG. 2 shows the demand information for two hot areas. In a case where an additional hot area is identified, the demand information (not shown) will be also generated for the hot area.

The demand information is configured to include, for example, at least a hot area spot (demand spot) and demand peak time (demand time). If needed, the demand information may be configured to include an area ID, the number of necessary drivers, and a demand prediction graph.

The area ID is information for uniquely identifying each of a plurality of hot areas which are identified for one predetermined period of time.

The hot area spot is information which indicates the location of the hot area which has been identified. The hot area spot may be information which indicates the latitude and longitude of one representative spot of the hot area, or information in which a hot area or a representative one spot of the hot area is plotted on a map, or both of these, as shown in FIG. 2.

As described above, the demand peak time is information which indicates the peak time of the demand which is predicted for the hot area. The number of necessary drivers is information which indicates the number of drivers that matches the demand, for example, the number of drivers that is predicted to be able to meet the demand in the hot area without excess or shortage.

The demand prediction graph may be omitted from the demand information. Conversely, when the demand peak time and the number of necessary drivers can be identified from the demand prediction graph which is included in the demand information, the demand peak time and the number of necessary drivers may be omitted from the demand information.

The demand information configured as described above is generated by the demand prediction device 2, and is provided to the vehicle dispatch device 1.

<Change-Over-Time Information on Unsuitability Level>

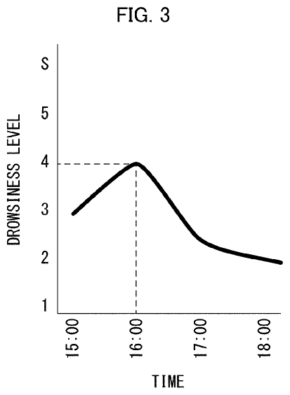

FIG. 3 is a graph showing an example of change-over-time information on the unsuitability level. In Embodiment 1, the change-over-time information on the unsuitability level is, for example, a driver's drowsiness estimation graph.

The estimation section 33 outputs the change-over-time information on drivers' drowsiness level which has been estimated, the change-over-time information being information for a predetermined period of time, e.g., from the present time 15:00 to 18:00 which is three hours later from the present time. For example, the change-over-time information is a drowsiness estimation graph which has been created by plotting the drowsiness level on the vertical axis and the time in a predetermined period of time on the horizontal axis, as illustrated in FIG. 3.

Note that any existing evaluation method could be employed as an evaluation method of the drowsiness level. It is possible to employ, for example, an evaluation method of New Energy and Industrial Technology Development Organization (NEDO). According to the evaluation method of NEDO, the degree of drowsiness is graded in five levels from drowsiness level 1 (not drowsy at all) to drowsiness level 5 (very drowsy). A sleeping state is evaluated as drowsiness level S.

The estimation section 33 generates, for each of the drivers, the change-over-time information on the drowsiness level, the change-over-time information being configured as described above. Then, the change-over-time information is provided to the vehicle dispatch device 1 from each in-vehicle system 3.

It should be noted that the change-over-time information may be information in any format, provided that it is possible to identify, from the information, the maximum value of the drowsiness level and the time at which the maximum value would be reached in a predetermined period of time. The change-over-time information may be, for example, a table in which estimated drowsiness levels at respective predetermined times within a predetermined period of time are arranged in chronological order. Hereinafter, the maximum value of the drowsiness level is referred to as a peak drowsiness level, and the time at which the maximum value is estimated to be reached is referred to as a drowsiness peak time.

<Availability Table>

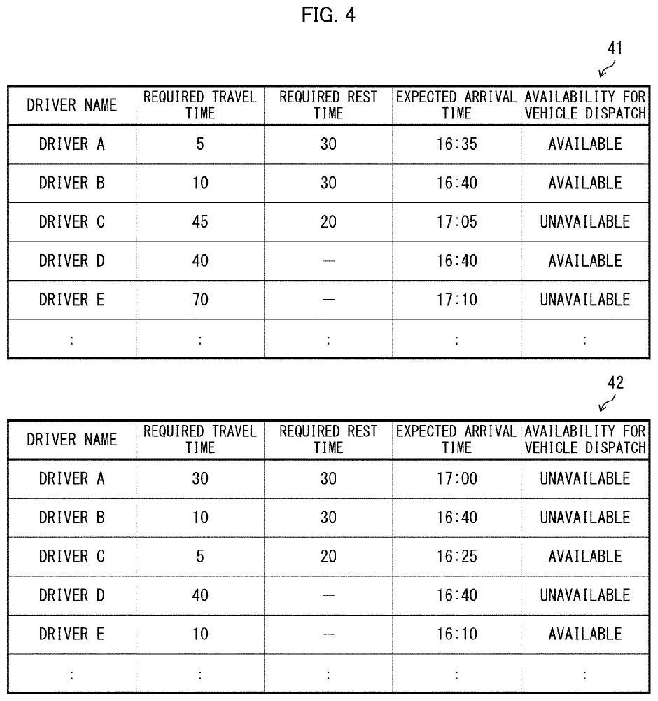

FIG. 4 is a chart illustrating an example of a data structure of the availability table 111. The availability table 111 is generated, for each of the hot areas identified, by the vehicle dispatch supporting section 23. The availability table 41 shown in FIG. 4 is an example of the availability table 111 which is generated for the hot area that is identified by the area ID “AREA0001” shown in FIG. 2. The availability table 42 is an example of the availability table 111 which is generated for the hot area that is identified by the area ID “AREA0002”.

The availability table 111 includes, for example, respective columns of “driver name”, “required travel time”, “required rest time”, “expected arrival time”, and “availability for vehicle dispatch”.

In the column of “driver name”, stored is identification information for identifying a driver. The driver name may be any character string, provided that the driver can be uniquely identified. The driver name may be the name of the driver, an employee number in the taxicab company, or the like.

In the column of “required travel time”, stored is a time necessary for the driver to travel from the present location to the demand spot, specifically, to the hot area spot. The vehicle dispatch supporting section 23 calculates the required travel time, on the basis of a distance between the present location of the driver and the hot area spot. The required travel time may be calculated by any well-known method.

In the column of “required rest time”, stored is a time necessary for the driver to take a rest in order to make the unsuitability level not more than a predetermined threshold value. In Embodiment 1, the required rest time is defined, for example, to be a time necessary for the driver to take a rest in order to make the peak drowsiness level, which the driver is predicted to have, less than 3, i.e., not more than 2. In Embodiment 1, respective required rest times have been associated with peak drowsiness levels in advance. Thus, the vehicle dispatch supporting section 23 identifies, as the required rest time, a required rest time corresponding to the peak drowsiness level of the driver in a predetermined period of time. In another example, the vehicle dispatch supporting section 23 may calculate, individually for each of the drivers, the required rest time that corresponds to the drowsiness level, in consideration of an individual sleeping habit of the driver. In Embodiment 1, for a driver(s) whose drowsiness level is predicted to reach not less than 3 in a predetermined period of time, the vehicle dispatch supporting section 23 may determine that no rest is necessary and may omit the process of determining the required rest time

In the column of “expected arrival time”, stored is the time at which the driver can arrive at the demand spot in a condition in which the unsuitability level is not more than the predetermined threshold value. The vehicle dispatch supporting section 23 calculates the expected arrival time by adding, to the present time, the required rest time in addition to the required travel time. In Embodiment 1, the expected arrival time thus calculated indicates the time at which the driver can arrive at the hot area spot in a condition in which the drowsiness level is not more than 2.

In the column of “availability for vehicle dispatch”, stored is a result of determining whether or not the driver can be dispatched to the hot area spot. The vehicle dispatch supporting section 23 compares the expected arrival time with the demand time (the demand peak time in the hot area in Embodiment 1), and determines, for a driver(s) whose expected arrival time comes before the demand time, that the driver is available for vehicle dispatch. In the availability table 111, the driver who is determined to be available for vehicle dispatch means a driver who can arrive at the demand spot by the demand time in a condition in which the unsuitability level is not more than the predetermined threshold value.

In the column of “availability for vehicle dispatch”, for example, flag information may be stored. In the example shown in FIG. 4, the flag information indicated as “available” means that the driver is available for vehicle dispatch, and the flag information indicated as “unavailable” means that the driver is not available for vehicle dispatch.

<Vehicle Dispatch Result Information>

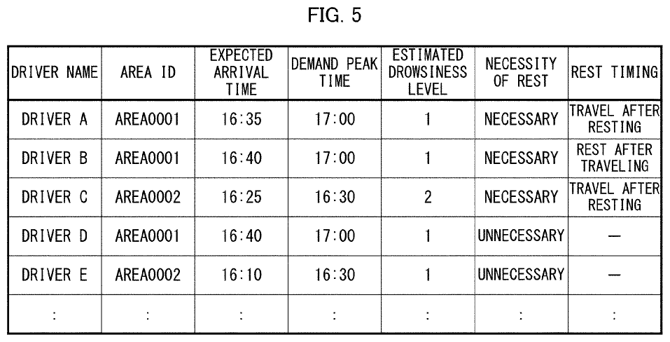

FIG. 5 is a chart illustrating an example of a data structure of the vehicle dispatch result information 112. The vehicle dispatch result information 112 shown in FIG. 5 may be generated, for example, such that a single piece of the vehicle dispatch result information 112 is generated for a single prediction of demand for vehicle dispatch in one predetermined period of time. When the demand prediction device 2 predicts, one time, the demand for vehicle dispatch in one predetermined period of time and outputs, to the vehicle dispatch device 1, demand information for each of the hot areas identified, the vehicle dispatch supporting section 23 of the vehicle dispatch device 1 may generate one piece of the vehicle dispatch result information 112 shown in FIG. 5 for the above-described one prediction.

The vehicle dispatch result information 112 is information which indicates which driver is assigned to which hot area in the above described predetermined period of time. The vehicle dispatch result information 112 may be configured as, for example, a table.

The vehicle dispatch result information 112 is configured to include, for example, respective columns of “driver name” and “area ID”. If needed, the vehicle dispatch result information 112 may be configured to further include respective columns of “expected arrival time”, “demand peak time”, and “estimated drowsiness level”. In addition, the vehicle dispatch result information 112 may be configured to further include respective columns of “necessity of rest” and “rest timing”. Each of the respective columns of “necessity of rest” and “rest timing” will be described in detail in Variation 2 later.

In the column of “driver name”, stored is identification information for identifying the driver. The identification information can be the same as that in the availability table 111.

In the column of “area ID”, stored is an area ID of the hot area which is a destination to which a driver concerned is to be dispatched.

In the column of “expected arrival time”, stored is the expected arrival time of the driver concerned. The vehicle dispatch supporting section 23 can read out the expected arrival time of the driver concerned, from the availability table 111 (FIG. 4) of the hot area which is assigned to the driver concerned.

In the column of “demand peak time”, stored is the demand peak time in the hot area concerned. The vehicle dispatch supporting section 23 can read out the demand peak time of the hot area which is assigned to the driver concerned, from the demand information (FIG. 2) of the hot area.

In the column of “estimated drowsiness level”, stored is the estimated drowsiness level of the driver concerned, at the expected arrival time of the driver concerned. The vehicle dispatch supporting section 23 can extract the drowsiness level at the expected arrival time, from the drowsiness estimation graph (FIG. 3) which has been generated for the driver concerned.

As described above, the vehicle dispatch result information 112, which is generated by the vehicle dispatch supporting section 23, is stored in the storage section 11. The vehicle dispatch result information 112 stored in the storage section 11 is referred to as appropriate by the notification section 24 and by the checking section 25 which will be described later.

More specifically, the notification section 24 can notify, by referring to the vehicle dispatch result information 112, each of the drivers of the hot area which is the destination of dispatch.

<Overview of Process Flow>

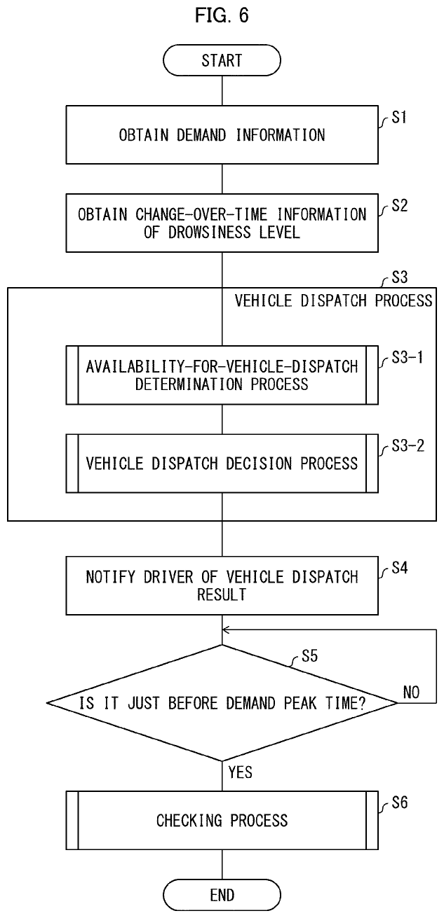

FIG. 6 is a flow chart showing a flow of a process which is carried out by the vehicle dispatch device 1.

In step S1 (demand information obtaining step), the demand information obtaining section 21 obtains, from the demand prediction device 2, demand information for each of hot areas which are identified for one predetermined period of time. The demand information thus obtained here includes, for example, a hot area spot, demand peak time, and the number of necessary drivers, as illustrated in FIG. 2.

In step S2 (biological condition obtaining step), the driver information obtaining section 22 obtains, for each of drivers, change-over-time information on the unsuitability level in the above-described predetermined period of time, the change-over-time information being obtained from the estimation section 33. The change-over-time information on the unsuitability level may be, for example, a drowsiness estimation graph as shown in FIG. 3

In step S3 (vehicle dispatch supporting step), the vehicle dispatch supporting section 23 carries out a vehicle dispatch process. The vehicle dispatch process is a process for deciding which driver is to be dispatched to which hot area. In Embodiment 1, the vehicle dispatch process includes, for example, an availability-for-vehicle-dispatch determination process in step S3-1 and a vehicle dispatch decision process in step S3-2.

In the availability-for-vehicle-dispatch determination process in step S3-1, the vehicle dispatch supporting section 23 outputs, for each of the hot areas, an availability table 111 which indicates a result of determining whether or not each of the drivers is available for vehicle dispatch, in response to input of, for example,

(1) a hot area spot of each of the hot areas,

(2) demand peak time of each of the hot areas,

(3) peak drowsiness level of each of the drivers,

(4) drowsiness peak time of each of the drivers, and

(5) present location of each of the drivers.

In the vehicle dispatch decision process in step S3-2, the vehicle dispatch supporting section 23 outputs the vehicle dispatch result information 112 that indicates which driver is to be dispatched to which hot area, in response to input of, for example,

(1) the availability table 111 for each of the hot areas which have been outputted in step S3-1, and

(2) the number of necessary drivers for each of the hot areas.

In step S3-2, the vehicle dispatch supporting section 23 may determine, for each of the drivers, the necessity of rest, and may also decide rest timing which is to be proposed to each of the drivers who have been determined that rest is necessary (Variation 2 described later).

In step S4, the notification section 24 provides notification to the in-vehicle system 3 of each of the drivers, on the basis of the vehicle dispatch result information 112 which indicates the result of the vehicle dispatch process in step S3. The notification section 24, for example, transmits, to the in-vehicle system 3 of a driver to which one or more hot areas are assigned, the hot area spot(s) of the hot area(s) which has/have been assigned to the driver and a target arrival time. The target arrival time may be one or both of the demand peak time in the hot area and the expected arrival time which has been calculated for the above-described hot area and driver. The notification section 24 may notify each of the drivers of the necessity of rest and rest timing, for preparation of operations at the demand peak time.

The control section 10 of the vehicle dispatch device 1 may further include the checking section 25. In a case where the control section 10 includes the checking section 25, the checking section 25 may further carry out steps S5 and S6 (Variation 1 described below).

<Variation 1>

The checking section 25 may check a condition of a driver who appears to stand by in a hot area, just before a demand peak, and may make a final check as to whether it is truly safe that the driver operates in the hot area.

In step S5, the checking section 25 refers to the vehicle dispatch result information 112 and monitors whether or not the present time has reached time which is a predetermined period of time (for example, 15 minutes) before the demand peak time in any one hot area. When the present time has become the time which is the predetermined period of time before the demand peak time in the any one hot area, the checking section 25 proceeds with the process from YES in step S5 to step S6.

In step S6, the checking section 25 carries out a checking process. Specifically, the checking section 25 first identifies a driver(s) who is/are assigned to the hot area just before the demand peak time in the hot area. The checking section 25 then obtains, from the estimation section 33, an actual measured value of the unsuitability level (e.g., drowsiness level) at the present time, the unsuitability level having been determined, for the driver(s) identified, on the basis of biological information. The checking section 25 may cancel the above assignment of any of the driver(s) to the hot area in a case where the unsuitability level of that driver(s) at the present time just before, for example, 15 minutes, before carrying out an operation is not less than a predetermined threshold value (e.g., a drowsiness level of not less than 3).

The notification section 24, which has received a decision of such cancellation from the checking section 25, may transmit, to the in-vehicle system 3 of the driver whose assignment has been cancelled, a notification to the effect that the driver is prohibited from driving. The notification may further include a message which recommends, to the driver whose assignment has been cancelled, to rest.

According to the above configuration, the unsuitability level is reconfirmed just before (e.g., 15 minutes before) the demand peak time for each of the drivers who were predicted to be capable of arriving at the hot area in the absence of drowsiness and then were dispatched to the hot area a predetermined period of time (e.g., 3 hours) before the demand peak time. Such check just before the demand peak time makes it possible to provide notification of cancellation of driving to a driver who is determined to have an unsuitability level that is high to a degree that may cause a trouble in safe driving. This makes it possible to avoid a situation in which safety is sacrificed for efficiency (revenue). This consequently makes it possible to realize the vehicle dispatch system 100 which while putting the highest priority on safety, can enhance the efficiency or the revenue.

It should be noted that the checking section 25 may be incorporated in the vehicle dispatch supporting section 23 as a part of functions which the vehicle dispatch supporting section 23 has.

<Variation 2>

In step S3-2, when generating the vehicle dispatch result information 112, the vehicle dispatch supporting section 23 may generate, for each of the drivers to whom the hot area was assigned, information which indicates a manner in which the driver can take a rest, and include this information in the dispatch result information 112. In Variation 2, the vehicle dispatch result information 112 shown in FIG. 5 includes respective columns of “necessity of rest” and “rest timing”.

In the column of “necessity of rest”, stored is necessity-of-rest information which indicates whether or not a driver concerned needs to take a rest before the demand peak time comes. It is possible to store, for example, flag information as the necessity-of-rest information. In the example shown in FIG. 5, the flag information indicated as “necessary” means that the driver needs rest, and the flag information indicated as “unnecessary” means that the driver does not need rest.

The vehicle dispatch supporting section 23 refers to the drowsiness estimation graph (FIG. 3) which has been generated for the driver concerned. Then, the vehicle dispatch supporting section 23 may determine, on the basis of the drowsiness estimation graph described above, that rest is not necessary for a driver whose drowsiness level has never reached not less than 3 in a predetermined period of time. Then, the vehicle dispatch supporting section 23 may store the flag information which indicates “unnecessary” in the column of “necessity of rest”. In other words, the vehicle dispatch supporting section 23 may determine that rest is not necessary for a driver who is predicted to maintain a drowsiness level of 1 or 2 in a predetermined period of time.

On the other hand, the vehicle dispatch supporting section 23 may determine, on the basis of the drowsiness estimation graph, that rest is necessary for a driver in a case where the drowsiness level of the driver has reached not less than 3 even once in a predetermined period of time. The vehicle dispatch supporting section 23 may store the flag information which indicates “necessary” in the column of “necessity of rest”.

It should be noted that the above-described determination of the necessity of rest may have already been carried out in step S3-1, and a result of determining the necessity of rest may be stored in the availability table 111. In this case, the vehicle dispatch supporting section 23 may reflect, in the column of “necessity of rest” in the vehicle dispatch result information 112, the result of determining the necessity of rest, the result having been stored in the availability table 111.

In the column of “rest timing”, stored is advice information which indicates, to a driver concerned, a proposed manner of taking a rest. The advice information is not particularly limited in data format. The data format of the advice information may be text data which describes the manner of taking a rest, sound data or a sign, or structured data which specifies a place and time for taking a rest.

In Variation 2, the advice information is, for example, information which indicates one of a first rest method in which the driver first takes a rest at the present location and then travels to the hot area and a second rest method in which the driver first travels to the hot area and then takes a rest. The character string of “travel after resting” shown in FIG. 5 refers to the first rest method, and the character string of “rest after traveling” means the second rest method.

The vehicle dispatch supporting section 23 may decide a rest method which the driver is advised to follow, depending on whether a drowsiness peak time identified from the drowsiness estimation graph of the driver is closer to the present time or to the demand peak time. Specifically, when the drowsiness peak time is closer to the present time than to the demand peak time, the vehicle dispatch supporting section 23 may decide to advise the above-described driver to follow the first rest method, and stores, in the column of “rest timing”, the advice information which indicates “travel after resting”. When the drowsiness peak time is closer to the demand peak time than to the present time, the vehicle dispatch supporting section 23 may decide to advise the above-described driver to follow the second rest method, and stores, in the column of “rest timing”, the advice information which indicates “rest after traveling”.

According to the above-described configuration, the notification section 24 which has referred to the vehicle dispatch result information 112 can provide, in step S4, notification of a manner of taking a rest suitable for a driver who needs rest.

Note that in a case where the drowsiness peak time (time at which the level of the biological condition is at a peak) is closer to the present time than to the demand time, the vehicle dispatch supporting section 23 may decide the driver's present location as a resting place, whereas in a case where the drowsiness peak time is closer to the demand time than to the present time, the vehicle dispatch supporting section 23 may decide the demand spot as the resting place. In this case, the notification section 24 provides notification of at least the demand spot, the demand time in the demand spot, and the resting place, to a driver to whom the vehicle dispatch supporting section 23 has assigned the demand spot.

<Availability-for-Vehicle-Dispatch Determination Process>

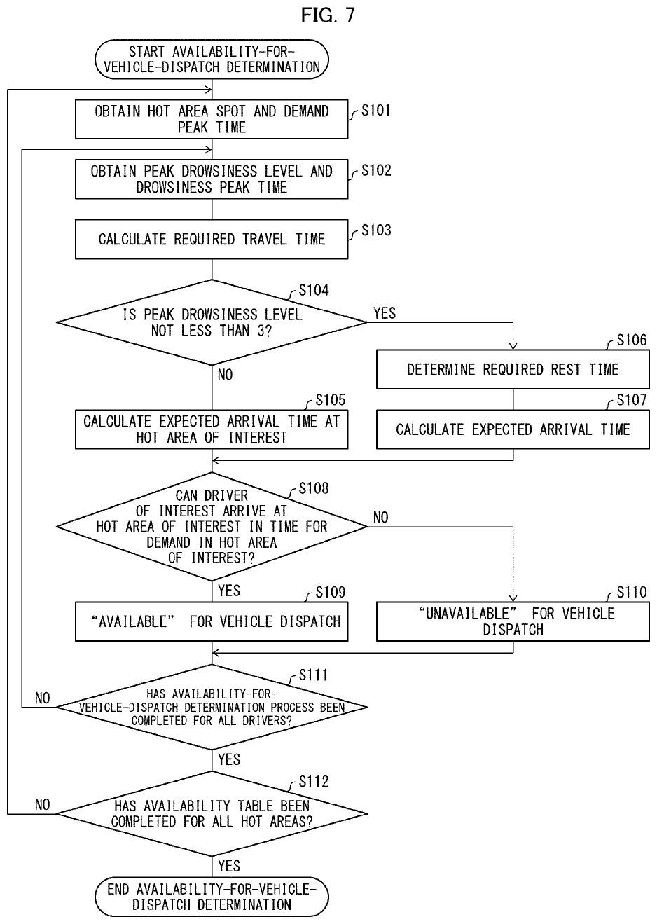

FIG. 7 is a flow chart showing a flow of an availability-for-vehicle-dispatch determination process which is carried out by the vehicle dispatch supporting section 23. The availability-for-vehicle-dispatch determination process illustrated in FIG. 7 corresponds to step S3-1 shown in FIG. 6.

In step S101, the vehicle dispatch supporting section 23 obtains a hot area spot and demand peak time. For example, the vehicle dispatch supporting section 23 determines, as a hot area of interest which is to be subjected to the availability-for-vehicle-dispatch determination process, one of a plurality of hot areas which have been identified by the demand prediction device 2 for one predetermined period of time. The vehicle dispatch supporting section 23 reads out demand information on the above-described hot area of interest, from the demand information (FIG. 2) of the hot areas which has been obtained in step S1 of FIG. 6. The vehicle dispatch supporting section 23 obtains, from the demand information on the hot area of interest, the hot area spot and the demand peak time of the hot area of interest.

In step S102, the vehicle dispatch supporting section 23 obtains a peak drowsiness level and drowsiness peak time. For example, the vehicle dispatch supporting section 23 identifies, as a driver of interest that is to be subjected to the availability-for-vehicle-dispatch determination process, one of the drivers who are managed by the taxicab company and who are working on the day. The vehicle dispatch supporting section 23 reads out the drowsiness estimation graph for the driver of interest, the drowsiness estimation graph having been obtained in step S2 of FIG. 6. The vehicle dispatch supporting section 23 obtains the peak drowsiness level and the drowsiness peak time of the driver of interest, from the drowsiness estimation graph of the driver of interest.

In step S103, the vehicle dispatch supporting section 23 calculates a required travel time. For example, the vehicle dispatch supporting section 23 reads out the present location of the driver of interest, the present location being obtained for the driver of interest by the driver information obtaining section 22 from the location information obtaining section 34. The vehicle dispatch supporting section 23 calculates the required travel time, on the basis of the present location of the driver of interest and the hot area spot which has been obtained in step S101. The required travel time refers to an amount of time necessary for the driver of interest to travel from the present location to the hot area spot of the hot area of interest. There is no particular limitation on a method of calculating the required travel time. The vehicle dispatch supporting section 23 may simply calculate the required travel time on the basis of a distance from the present location to the hot area spot. Alternatively, the vehicle dispatch supporting section 23 may calculate the required travel time on the basis of a travel distance of a route from the present location to the hot area spot, the route having been selected from map information. The vehicle dispatch supporting section 23 may calculate the travel time in additional consideration of traffic congestion information on the route.

In step S104, the vehicle dispatch supporting section 23 determines whether or not the peak drowsiness level of the driver of interest is not less than a predetermined threshold value, the peak drowsiness level having been obtained in step S102. For example, the vehicle dispatch supporting section 23 determines whether the peak drowsiness level is not less than 3 or less than 3. In Embodiment 1, the vehicle dispatch supporting section 23 determines, as a drowsiness level of not less than 3, the drowsiness level S which means that the driver is already sleeping at the present moment. In a case where the peak drowsiness level of the driver of interest is less than 3, that is, in a case where the peak drowsiness level is 1 or 2, the vehicle dispatch supporting section 23 proceeds with the process from NO in step S104 to S105. In a case where the peak drowsiness level of the driver of interest is not less than 3, that is, in a case where the peak drowsiness level is any of 3 to 5 or S, the vehicle dispatch supporting section 23 proceeds with the process from YES in step S104 to S106.

In step S105, the vehicle dispatch supporting section 23 calculates the expected arrival time at the hot area of interest on the basis of the present time and the required travel time. In Embodiment 1, the vehicle dispatch supporting section 23 may calculate the expected arrival time on the basis of the required travel time without consideration of the required rest time for a driver of interest whose drowsiness level does not become not less than 3 in a predetermined period of time. For example, the vehicle dispatch supporting section 23 calculates the expected arrival time by adding the required travel time to the present time. As described above, the expected arrival time indicates the time at which the driver can arrive at the hot area spot in a condition in which the drowsiness level is not more than 2. Alternatively, the vehicle dispatch supporting section 23 may uniformly determine the required rest time as 0 minutes for the driver of interest whose drowsiness level does not become not less than 3, and calculate, for this driver, the expected arrival time on the basis of the required travel time.

In step S106, the vehicle dispatch supporting section 23 determines the required rest time on the basis of the peak drowsiness level. In Embodiment 1, the required rest time has a fixed value which is associated with one of drowsiness levels. The vehicle dispatch supporting section 23 determines a required rest time which is associated with a drowsiness level that is indicated by the peak drowsiness level. The required rest time may be determined in advance in accordance with a difference between the peak drowsiness level and the predetermined threshold value. For example, when the drowsiness level 3 is associated in advance with a required rest time of “20 minutes” and the peak drowsiness level of a driver of interest is 3, the required rest time of the driver of interest is determined as “20 minutes”. In a case where the peak drowsiness level is higher than 3 and the difference between the peak drowsiness level and 3 becomes larger, a longer required rest time may be associated

In step S107, the vehicle dispatch supporting section 23 calculates the expected arrival time at the hot area of interest in consideration of the required rest time. For example, the vehicle dispatch supporting section 23 calculates the expected arrival time on the basis of the present time, the required travel time, and the required rest time. More specifically, the vehicle dispatch supporting section 23 may calculate the expected arrival time by adding, to the present time, the required travel time and additionally the required rest time. Further, the vehicle dispatch supporting section 23 may calculate the expected arrival time in consideration of the drowsiness peak time (time at which the level of the biological condition is at a peak). For example, the expected arrival time employed may be later one of (i) first time which can be obtained by adding the required travel time and the required rest time to the present time, or (ii) second time which is obtained by adding the required rest time to the drowsiness peak time. This makes it possible to avoid the following inconvenience. That is, in cases where the drowsiness peak time is immediately before the demand peak time, there may be a case where even if a driver could arrive at the hot area spot by the demand peak time, it would not be possible to eliminate drowsiness of the driver in time for the demand peak time. The above configuration makes it possible to eliminate, in such a case, the inconvenience that the expected arrival time is estimated to be earlier than the actual time.

In addition, for the drowsiness level S, that is, for the driver of interest who is already sleeping, the estimation section 33 of the in-vehicle system 3 may predict expected wake-up time by using the biological information on the driver of interest, the biological information having been obtained from the biological information obtaining section 32. For example, the estimation section 33 may analyze the time at which a nap started, the drowsiness level at the start of the nap, the present sleep depth which is obtained from other biological information, and the like, and predict the expected wake-up time of the driver of interest. The vehicle dispatch supporting section 23 can calculate the expected arrival time of the driver of interest whose drowsiness level is S, by adding the expected wake-up time which has been estimated by the estimation section 33 and the required travel time.

In step S108, the vehicle dispatch supporting section 23 determines whether the driver of interest can arrive at the hot area of interest in time for the demand in the hot area of interest. For example, in a case where the expected arrival time is before the demand peak time, the vehicle dispatch supporting section 23 may determine that the driver can arrive. In this case, the vehicle dispatch supporting section 23 proceeds with the process from YES in step S108 to step S109. In a case where the expected arrival time is later than the demand peak time, the vehicle dispatch supporting section 23 may determine that it is not possible to arrive. In this case, the vehicle dispatch supporting section 23 proceeds with the process from NO in step S108 to step S110. In another example, if the expected arrival time is within a predetermined time, e.g. not more than 5 minutes, from the demand peak time even in a case where the expected arrival time is later than the demand peak time, the vehicle dispatch supporting section 23 may determine that it is possible to arrive.

In step S109, the vehicle dispatch supporting section 23 associates the determination result “available” for vehicle dispatch, with a driver of interest who is determined to be capable of arriving at the hot area spot by the demand peak time in a condition in which the drowsiness level is less than 3. Specifically, the vehicle dispatch supporting section 23 stores flag information that indicates “available”, which means vehicle dispatch is possible, in the column of “availability for vehicle dispatch” of the driver of interest in the availability table 111 shown in FIG. 4.

In step S110, the vehicle dispatch supporting section 23 associates the determination result “unavailable” for vehicle dispatch, with a driver of interest who is determined to be incapable of arriving at the hot area spot by the demand peak time in a condition in which the drowsiness level is less than 3. Specifically, the vehicle dispatch supporting section 23 stores flag information that indicates “unavailable”, which means vehicle dispatch is impossible, in the column of “availability for vehicle dispatch” of the driver of interest in the availability table 111 shown in FIG. 4. This is the end of the availability-for-vehicle-dispatch determination process for one driver of interest.

In step S111, the vehicle dispatch supporting section 23 determines whether or not the availability-for-vehicle-dispatch determination process has been completed for all of the drivers who are working on the day, with regard to one hot area of interest which has been identified in step S101. When there is any driver left undetermined with regard to the availability for vehicle dispatch, the vehicle dispatch supporting section 23 returns the process from NO in step S111 to step S102, and repeats processing of step S102 and subsequent steps for a next driver of interest. In a case where the availability-for-vehicle-dispatch determination process has been completed for all of the drivers, the vehicle dispatch supporting section 23 proceeds with the process from YES in step S111 to step S112. This is the end of the availability-for-vehicle-dispatch determination process for one hot area of interest, and one availability table 111 has been completed for the hot area of interest.

In step S112, the vehicle dispatch supporting section 23 determines whether or not the availability table 111 has been completed for all of the hot areas which have been identified for the predetermined period of time. When there is any hot area for which the availability table 111 is not generated, the vehicle dispatch supporting section 23 returns the process from NO in step S112 to step S101, and repeats processing in step S101 and subsequent steps for a next hot area of interest. In a case where the vehicle dispatch supporting section 23 has generated the availability tables 111 for all of the hot areas, the vehicle dispatch supporting section 23 ends a series of such availability-for-vehicle-dispatch determination processes through YES in step S112. The availability table 111 is generated as described above for each of the hot areas for the one predetermined period of time, and is stored in the storage section 11.

<Vehicle Dispatch Decision Process>

The vehicle dispatch supporting section 23 carries out the vehicle dispatch decision process of step S3-2, after having identified, by the availability-for-vehicle-dispatch determination process in step S3-1, the driver(s) who can finish both of traveling to the demand spot and taking a rest by the demand time. The vehicle dispatch decision process is a process for selecting one or more drivers who are to be assigned to the demand spot. In Embodiment 1, for example, the vehicle dispatch supporting section 23 may select, in the vehicle dispatch decision process, one or more drivers who are to be assigned to the demand spot from among drivers who have been determined, in the availability-for-vehicle-dispatch determination process, to be capable of finishing both of traveling to the demand spot and taking a rest. In another embodiment, the one or more drivers who are to be assigned to the demand spot is not limited to the driver(s) who has/have been determined in the availability-for-vehicle-dispatch determination process, and can be a driver who has been specified by a user on the basis of the result of the availability-for-vehicle-dispatch determination process.

In Embodiment 1, the vehicle dispatch supporting section 23 may refer to the demand information (FIG. 2) of each of the hot areas and the availability table 111 (FIG. 4) which has been generated for each of the hot areas. Then, the vehicle dispatch supporting section 23 may assign, preferentially from the demand spot where the number of necessary drivers is relatively larger, the drivers who have been identified.

Alternatively, the vehicle dispatch supporting section 23 may decide an assignment pattern of drivers and hot areas which are destinations of dispatch so that the number of surplus drivers who are not assigned to any hot area will be the smallest.

Alternatively, the vehicle dispatch supporting section 23 may assign the drivers to the hot areas preferentially from a hot area where the highest sales are expected. For example, on the basis of past records, the vehicle dispatch supporting section 23 may preferentially assign a driver(s) to a hot area(s), such as a hot area in the vicinity of a station, where many passengers who are to travel long distances would appear.

Alternatively, the vehicle dispatch supporting section 23 may assign the drivers so that respective travel distances of the drivers to the hot area spots become the shortest. For example, assume a case where a driver A is available for vehicle dispatch to either a hot area A or a hot area B and the present location of the driver A is closer to the hot area B than to the hot area A. In this case, the vehicle dispatch supporting section 23 assigns the driver A to the hot area B.

Alternatively, the vehicle dispatch supporting section 23 may determine, on the basis of past taxicab driver work experiences of a driver, a hot area which is to be assigned to the driver. For example, the vehicle dispatch supporting section 23 may identify, on the basis of past records the driver, an area in which the driver is frequently traveling on a regular basis, and assign, to the driver, a hot area close to that area. This configuration makes it possible to assign, to each of drivers, a hot area which is familiar to the driver and in which the driver knows roads well. This consequently allows for vehicle dispatch that results in a higher efficiency (profitability).

<Example of Notification Screen>

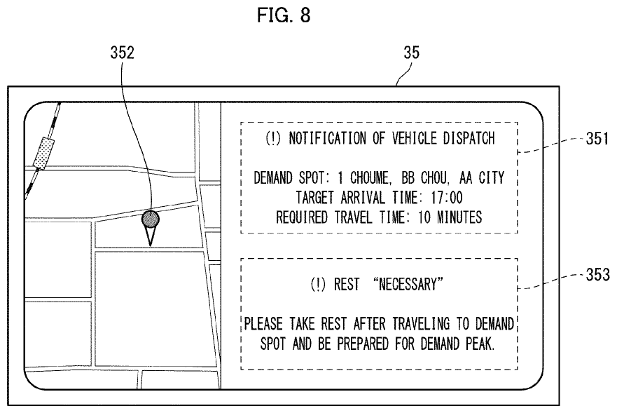

FIG. 8 is a diagram illustrating an example of a notification which is outputted from the information outputting section 35 of the in-vehicle system 3. FIG. 8 shows, as an example of a notification, a notification screen which is displayed on the information outputting section 35 that is configured as a display device.

The in-vehicle system 3 receives, from the notification section 24 of the vehicle dispatch device 1 by operation of a control section (not shown) which is provided in the in-vehicle system 3, at least the hot area spot of the hot area which has been assigned to the driver and the target arrival time. The in-vehicle system 3 arranges, in the notification screen, vehicle dispatch notification 351 that includes the hot area spot and the target arrival time which have been received, and causes the notification screen to be displayed on the information outputting section 35. The vehicle dispatch notification 351 on the notification screen may include the required travel time in addition to the hot area spot and the target arrival time. The required travel time may be calculated by the vehicle dispatch device 1 and then transmitted from the notification section 24, or may be calculated by the in-vehicle system 3 on the basis of the present location of the driver and the hot area spot. Further, on the map information, a hot area spot 352 may be superimposed and displayed.

The notification screen may further include a rest notification 353 for notifying the driver of the necessity of rest and the rest timing. Upon receipt of the necessity of rest and the rest timing from the notification section 24, the in-vehicle system 3 arranges, in the notification screen, the rest notification 353 which includes these pieces of received information, and causes the notification screen to be displayed on the information outputting section 35.

The driver can recognize when and where the driver should go, by looking at the notification screen which is displayed on the information outputting section 35. Further, when the notification screen includes the rest notification 353, the driver can recognize the necessity of rest and timing at which the rest should be taken in a case where the rest is necessary.

### Embodiment 2

The following will discuss in detail another embodiment of the present invention, with reference to drawings. Note that for convenience of explanation, any constituent element that is identical in function to a constituent element described in Embodiment 1 is given the same reference numeral, and a description thereof will be omitted here.

<Overview of Vehicle Dispatch System>

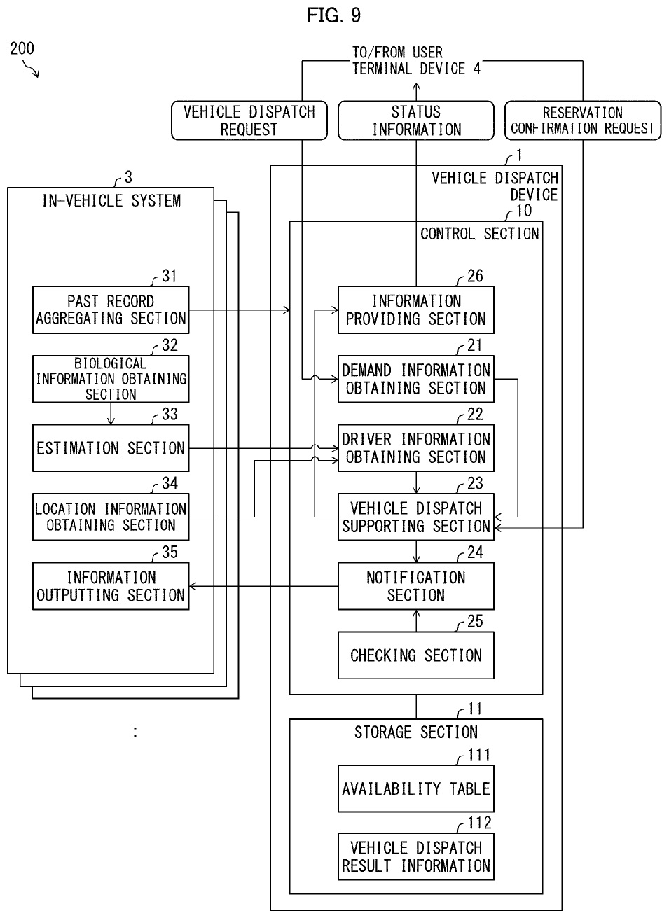

FIG. 9 is a block diagram illustrating a configuration of a vehicle dispatch system 200. In Embodiment 2, the vehicle dispatch system 200 is, for example, for a service provider to manage drivers and to match the drivers to users, the service provider operating a ride-share service.

In Embodiment 2, for example, the drivers are each a person who provides another person with a vacant seat of a private vehicle or the like (hereinafter, referred to as “vehicle”) when the person travels in the vehicle, that is, a person who offers a ride share. When there is a person whose condition such as a destination meets that of the driver and who would like to use the ride share, the person utilizes the vacant seat that is provided by the driver, and travels as a passenger together with the driver. Both of the driver and the passenger are users of the ride-share service that is operated by the service provider. In the following description, “user” refers to a person who utilizes the vacant seat in a ride share and “driver” refers to a person who provides a vacant seat so that those persons can be distinguished from each other. In the above-described ride-share service, the user may bear part of expenses which the driver incurs in connection with the traveling.

In Embodiment 2, “dispatch a vehicle” means that a vehicle dispatch device 1 which is operated by the service provider matches, to a user who desires to travel, a driver who meets a desired condition of the user, and dispatches the driver at time and a place which have been approved by the user.

The vehicle dispatch system 200 differs from the vehicle dispatch system 100 of Embodiment 1 in the following point. That is, the vehicle dispatch system 200 may not include the demand prediction device 2, and instead, the vehicle dispatch device 1 is connected to a user terminal device 4, which is operated by the user, so as to be capable of communicating with the user terminal device 4.

The user terminal device 4 transmits a ride-share condition to the vehicle dispatch device 1 via a communication network such as the Internet, and requests vehicle dispatch. The term “vehicle dispatch request” hereinafter means a message which is transmitted from the user terminal device 4 and which contains the ride-share condition for requesting vehicle dispatch.

In Embodiment 2, for example, the vehicle dispatch request contains a desired destination, desired ride time, and a desired ride spot as ride-share conditions. The desired destination refers to a user's destination. The desired ride spot refers to a place where the user desires to ride, that is, a rendezvous place. The desired ride time indicates rendezvous time which the user desires.

In Embodiment 2, the desired ride time corresponds to the demand time, and the desired ride spot corresponds to the demand spot.

(Configuration of In-Vehicle System)

In Embodiment 2, an in-vehicle system 3 includes a past record aggregating section 31. The past record aggregating section 31 aggregates a history of ride shares which a driver has made. For example, the past record aggregating section 31 may obtain, as history information, a ride-share start location, a ride-share end location, a travel distance, a travel time, travel costs, user information on a user who is a passenger, a user's assessment of a driver, a user's share of the travel costs, and the like.

(Configuration of Vehicle Dispatch Device)

In Embodiment 2, the control section 10 includes, for example, an information providing section 26 in addition to the sections of Embodiment 1.

Further, in the storage section 11, driver basic information and user basic information are stored. The driver basic information is information on drivers who are registered in the ride-share service and the user basic information is information on users who are registered in the ride-share service. The driver basic information may include a driver ID, a name, contact information, an address, a type of vehicle to be used, an assessment score which has been calculated by an assessment(s) by a user(s) who has/have shared a ride with the driver, and the like. The user basic information may include a user ID, a name, contact information, an address, a ride-share usage history, etc.

In Embodiment 2, the demand information obtaining section 21 receives a vehicle dispatch request from the user terminal device 4, and obtains at least the desired ride time and the desired ride spot.

The driver information obtaining section 22 obtains, from the location information obtaining section 34, the present location of each of the drivers who have been registered in advance. In addition, the driver information obtaining section 22 obtains, from the estimation section 33, change-over-time information on an unsuitability level in a predetermined period of time, the period including a time from the present time to the above-described desired ride time. The change-over-time information on the unsuitability level may be a drowsiness estimation graph. The driver information obtaining section 22 may also obtain, from the biological information obtaining section 32, the unsuitability level of the driver at the present time.

The vehicle dispatch supporting section 23 carries out an availability-for-vehicle-dispatch determination process (FIG. 7), and determines for each of the drivers whether or not the driver can arrive at the desired ride spot by the desired ride time at a drowsiness level of less than 3. The vehicle dispatch supporting section 23 generates an availability table 111 which indicates a determination result on availability for vehicle dispatch, and stores the determination result in the storage section 11.

In Embodiment 2, regardless of whether or not a peak drowsiness level is not less than 3, for each of all of the drivers, the vehicle dispatch supporting section 23 may identify a required rest time corresponding to the peak drowsiness level as in steps S106 and S107, and may calculate expected arrival time in consideration of the required rest time.

It should be noted that in Embodiment 2, it is assumed that a driver who meets the condition of the desired destination of a user is extracted by an extraction section (not shown) prior to or after the availability-for-vehicle-dispatch determination process which is carried out by the vehicle dispatch supporting section 23.

On the basis of the availability table 111 which has been generated by the vehicle dispatch supporting section 23, the information providing section 26 provides status information on each of the drivers to the user terminal device 4, as a response to the vehicle dispatch request described above. The status information includes, for example, at least information for identifying a driver and availability of the driver for vehicle dispatch. For example, the information providing section 26 can obtain these pieces of information from the column of “driver name” and the column of “availability for vehicle dispatch” in the availability table 111 (FIG. 4).

The status information may further include the expected arrival time as time at which the driver can arrive at the desired ride spot at an unsuitability level of not more than a predetermined threshold value, regardless of whether or not the driver arrives in time for the desired ride time. The information providing section 26 can obtain, for each of the drivers, the expected arrival time from the column of “expected arrival time” in the availability table 111.

In addition, the status information may include a predicted unsuitability level (e.g., drowsiness level) of the driver at the desired ride time. For example, the information providing section 26 can obtain the drowsiness level at the desired ride time from the drowsiness estimation graph (FIG. 3) for each of the drivers.

Further, the status information may include an assessment score of the driver. The information providing section 26 can obtain the assessment score of each of the drivers from the driver basic information (not shown).

The user terminal device 4 causes a display section of the user terminal device 4 to display the status information on each of the drivers, the status information having been transmitted from the information providing section 26. This allows the user to check the status information and select a driver with whom the user would like to share a ride. On receipt of a selection of a desired driver from the user, the user terminal device 4 returns, to the vehicle dispatch device 1, a message as a reservation confirmation request, the message including identification information on the above selected driver.

In response to receipt of the reservation confirmation request, the vehicle dispatch supporting section 23 carries out the vehicle dispatch decision process of step S3-2 shown in FIG. 6, and confirms vehicle dispatch of the selected driver to the user. The vehicle dispatch supporting section 23 may determine rest timing of the selected driver in the vehicle dispatch decision process, as in Embodiment 1. The vehicle dispatch supporting section 23 stores, in the storage section 11, the vehicle dispatch result information 112 which has been generated by carrying out the vehicle dispatch decision process.

The notification section 24 provides notification that the vehicle dispatch has been confirmed, to the in-vehicle system 3 of a vehicle of the selected driver. The notification section 24 may also provide notification of a resting place together, as in Embodiment 1. Further, in Embodiment 2, even in the case of a driver whose peak drowsiness level is less than 3 in a predetermined period of time, the notification section 24 may advise the driver that taking a short rest is recommended instead of telling that rest is unnecessary.

In Embodiment 2, an information outputting section 35 of the in-vehicle system 3 displays vehicle dispatch notification 351 (FIG. 8). On the basis of the notification by the notification section 24, the vehicle notification 351 may include the desired ride spot, the desired ride time, the desired destination, the basic information on the user, and the like. Further, the information outputting section 35 displays a rest notification 353 which may include, for example, a message that indicates whether the resting place is the present location of the driver or in the vicinity of the desired ride spot (demand spot).

The information providing section 26 may return, to the user terminal device 4, the basic information on the driver who has been firmly reserved, in response to the reservation confirmation request.

In Embodiment 2, the checking section 25 may refer to the vehicle dispatch result information 112 and check the drowsiness level of the above-described selected driver at a time point which is a predetermined period of time (e.g., 1 hour to 30 minutes) before the desired ride time. In a case where as a result of this check, the drowsiness level is found to be not less than the predetermined threshold value, the notification section 24 may request the above-described driver to take a rest so that the driver will awake at the desired ride time.

<Vehicle Dispatch Result Information>

In Embodiment 2, the vehicle dispatch result information 112 which is generated by the vehicle dispatch supporting section 23 may differ in the following points from the vehicle dispatch result information 112 in accordance with Embodiment 1 shown in FIG. 5.

In Embodiment 2, the vehicle dispatch result information 112 is information which indicates a matching result between a driver and a user.

The vehicle dispatch result information 112 is configured to include, for example, a column of “user basic information” and a column of “desired ride spot” in place of the column of “area ID”. Further, the vehicle dispatch result information 112 is configured to include a column of “desired ride time” in place of a column of “demand peak time”.

In the column of “user basic information”, stored is the basic information on the user to whom the driver is assigned. For example, the name, the contact information, etc. of the user may be stored.

In the column of “desired ride spot”, stored is the rendezvous place which has been approved by the user. In this column, stored is, for example, the desired ride spot which is contained in the vehicle dispatch request that has been transmitted from the user terminal device 4.

In the column of “desired ride time”, stored is the rendezvous time which has been approved by the user. It is possible to store, in this column, for example, the desired ride time which is originally specified by the user and which is included in the vehicle dispatch request that has been transmitted from the user terminal device 4. It is alternatively possible to store, in this column, the expected arrival time of the selected driver, the expected arrival time having been contained in the reservation confirmation request. It is alternatively possible to store, in this column, a period of time from the desired ride time which has been originally specified by the user to the expected arrival time of the driver.

In Embodiment 2, for a driver whose peak drowsiness level is less than 3 in a predetermined period of time up to the desired ride time, the vehicle dispatch supporting section 23 may decide to recommend taking a rest without determining the rest as unnecessary. In this case, the vehicle dispatch supporting section 23 stores, in the column of “necessity of rest”, flag information which indicates that rest is recommended. For a driver whose peak drowsiness level is not less than 3, the vehicle dispatch supporting section 23 stores, in the column of “necessity of rest”, flag information which indicates that taking a rest is essential as in Embodiment 1.

<Example of Result Screen>

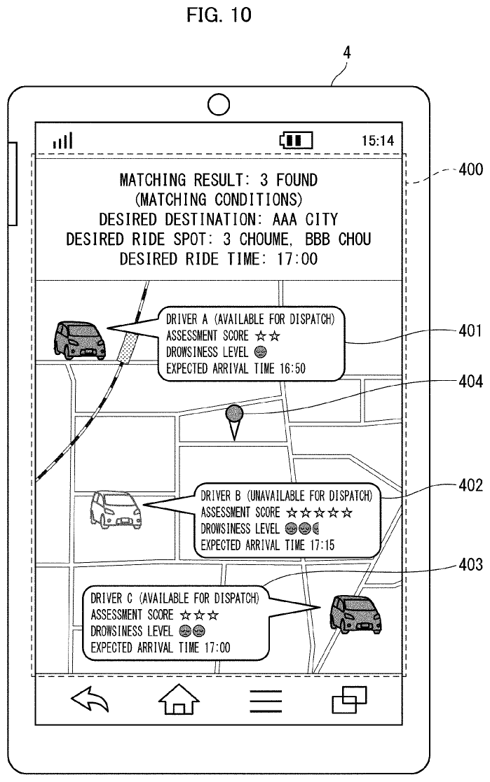

FIG. 10 is a diagram illustrating an example of a result screen which is displayed on the display section of the user terminal device 4. A result screen 400 is a screen which shows a search result of drivers who meet the ride-share conditions that the user desires.

In response to the vehicle dispatch request, the information providing section 26 of the vehicle dispatch device 1 transmits, to the user terminal device 4, the status information which includes the determination result on availability for vehicle dispatch with regard to each of the drivers. For example, as illustrated in FIG. 10, the user terminal device 4 may cause the display section to display, as the result screen 400, the status information having been received.

The result screen 400 may include, for example, map information. In the map information, it is possible to arrange an icon 404 which indicates the desired ride spot and an icon, for example, in the form of a car, which indicates the present location of the driver.

The result screen 400 includes the status information for each of the drivers who meet the conditions. In the example shown in FIG. 10, the status information is displayed in balloons 401 to 403 which are associated with respective icons that indicate present locations of three drivers. Among from these balloons, the balloons 401 and 403 each indicate the status information on a driver who has been determined to be available for vehicle dispatch. The balloon 402 indicates the status information on a driver who is determined to be unavailable for the vehicle dispatch.

As shown FIG. 10, the status information may include, for example, “driver name”, “availability for vehicle dispatch”, “assessment score”, “drowsiness level”, and “expected arrival time”.

Regarding the “availability for vehicle dispatch”, for example, the notation “(available for dispatch)” may be used for a driver who can arrive at the desired ride spot in time for the desired ride time, in a condition in which the drowsiness level is less than 3. On the other hand, the notation “(unavailable for dispatch)” may be used for a driver who cannot restore the drowsiness level to less than 3 by the desired ride time, or for a driver who cannot reach the desired ride spot by the desired ride time.

The “assessment score” may be represented by the number of star marks as shown in FIG. 10. For example, the higher number of star marks indicates that a higher reputation is obtained from users.

The “drowsiness level” indicates an expected drowsiness level of the driver at the desired ride time. The drowsiness level may be represented by the number of drowsy person icons, as shown in FIG. 10. For example, the higher number of drowsy person icons indicates a higher drowsiness level of the driver, that is, being drowsier.

The “expected arrival time” indicates the time at which the driver can arrive at the desired ride spot in a condition in which the drowsiness level is less than 3. That is, the driver whose expected arrival time is later than the desired ride time is displayed as “(unavailable for vehicle dispatch)” as shown in the balloon 402, and the expected arrival time may be displayed as “available time for vehicle dispatch”. As described above, even in a case where the status information on the driver is “unavailable for vehicle dispatch”, the expected arrival time, that is, the available time for vehicle dispatch is displayed together with the status information. This allows the user to know time after which the driver will be available for vehicle dispatch. User convenience is enhanced by displaying, together with the “available time for vehicle dispatch”, the status information on the driver who is not available for vehicle dispatch. This is because, in a case where the user can delay the desired ride time, the user can change the desired ride time in accordance with the available time for vehicle dispatch of the desired driver, and make a reservation.

As described above, the user can select, via the result screen 400, a favorite driver who meets the conditions from among drivers who are suitable for safe driving, or can make a reservation so that the favorite driver is dispatched in a condition that is suitable for safe driving.

[Software Implementation Example]

A function of the vehicle dispatch device 1 (hereinafter, referred to as “device”) can be realized by a program for causing a computer to function as the device, the program causing the computer to function as each of control blocks (in particular, each section of the control section 10) of the device.

In this case, the device includes, as hardware for executing the program, a computer which at least includes one control device (e.g., a processor) and at least one storage device (e.g., a memory). Each function described in the foregoing embodiments can be realized by executing the program by the control device and the storage device.

The program may be stored in one or more non-transitory storage mediums each of which can be read by the computer. This storage medium may or may not be provided in the above device. In the latter case, the program can be supplied to or made available to the device via any transmission medium such as a wired transmission medium or a wireless transmission medium.

Further, some or all of functions of respective control blocks can be realized by a logic circuit. For example, the present invention encompasses, in its scope, an integrated circuit in which a logic circuit that functions as each of the above-described control blocks. As another alternative, for example, it is possible to realize the functions of respective control blocks by a quantum computer.

Further, each of processes which are described in the foregoing embodiments can be executed by AI. In this case, the AI may be operated by the control device, or alternatively operated by another device (e.g., an edge computer, a cloud server, etc.).

[Supplementary Matters]

Some or all of the above-described embodiments can, for example, be described as below.

(Supplementary Note 1)

A vehicle dispatch device including:

a demand information obtaining section configured to obtain a demand spot at which demand for vehicle dispatch is expected and demand time at which the demand is expected;

a biological condition obtaining section configured to obtain, for each of drivers, a change over time of a biological condition from the present to the demand time; and

a vehicle dispatch supporting section configured to determine, for each of the drivers, a required rest time necessary for taking a rest in order to make a level of the biological condition less than a predetermined threshold value at the demand time in the change over time, and to identify, from among the drivers, one or more drivers who are capable of finishing both of traveling to the demand spot and taking the rest by the demand time.

In the above configuration, the vehicle dispatch supporting section determines the required rest time of each of the drivers, on the basis of the change over time of the level of the biological condition of the each driver. Then, the vehicle dispatch supporting section identifies a driver(s) who can finish both of traveling to the demand spot and taking a rest by the demand time.

With reference to the above-described determination of the vehicle dispatch supporting section, a driver(s) whose level of the biological condition is less than the predetermined threshold value can be easily dispatched to the demand spot so as to be in time for the demand time. The driver whose level of the biological condition is less than the predetermined threshold value means, for example, a driver whose health is suitable for driving or a driver whose health has been restored by taking a rest. In this way, the driver whose health is suitable for driving can safely operate at the demand spot without missing the timing of operation for expected demand. The above configuration can lead to vehicle dispatch which ensures both of safety and efficiency (revenue) at the same time.

(Supplementary Note 2)

The vehicle dispatch device according to Supplementary note 1, wherein the vehicle dispatch supporting section selects, from among the one or more drivers identified, one or more drivers who are to be assigned to the demand spot.

In the above configuration, a driver whose level of the biological condition is less than the predetermined threshold value can be assigned to the demand spot so as to be in time for the demand time. Examples of such a driver include a driver whose health is suitable for driving or a driver whose health has been restored by taking a rest. The above configuration can thus lead to vehicle dispatch which ensures both of safety and efficiency (revenue) at the same time.

(Supplementary Note 3)

The vehicle dispatch device according to Supplementary note 2, wherein:

the biological condition obtaining section is configured to obtain, for the one or more drivers having been assigned to the demand spot, the level of the biological condition at a time point which is a predetermined time before the demand time; and

the vehicle dispatch supporting section is configured to cancel assignment of a driver whose level of the biological condition obtained is not less than the predetermined threshold value, from among the one or more drivers having been assigned to the demand spot.

In the above configuration, even after having once assigned a driver to a demand spot, the vehicle dispatch device can cancel this assignment of the driver in a case where the level of the biological condition of the driver is not less than the predetermined threshold value at a time point which is a predetermined time before the demand time. According to this determination of cancellation, it is possible to provide, to the driver, notification which tells the driver not to operate at the demand spot at the demand time. This makes it possible to achieve safer vehicle dispatch while revenue is not prioritized.

(Supplementary Note 4)

The vehicle dispatch device according to any one of Supplementary notes 1 to 3, further including

a driver location obtaining section configured to obtain, for each of the drivers, a present location,

the vehicle dispatch supporting section being configured to:
calculate, for each of the drivers, expected arrival time at which each of the drivers arrives at the demand spot, on the basis of the required rest time and a required travel time which is necessary for each of the drivers to travel from the present location to the demand spot; and
identify one or more drivers whose expected arrival time is not later than the demand time, from among the drivers.

In the above configuration, the vehicle dispatch supporting section calculates the expected arrival time at which the driver can be at the demand spot in a safely operable state, in consideration of (a) the required rest time for making the biological condition of the driver less than the predetermined threshold value and (b) the required travel time which is necessary for the driver to travel from the present location to the demand spot. The vehicle dispatch supporting section can determine whether or not the driver can finish both of traveling to the demand spot and taking the rest by the demand time, on the basis of whether the expected arrival time calculated is earlier than the demand time.

(Supplementary Note 5)

The vehicle dispatch device according to Supplementary note 4, wherein

the vehicle dispatch supporting section is configured to calculate the expected arrival time in consideration of time at which the level of the biological condition is at a peak in a period from the present to the demand time in the change over time.

Even when the required rest time determined is short, there may be a case where a drowsiness peak comes just before the demand time. In this case, if timing for taking the rest is late, the demand time may pass before a state allowing for safe driving is restored. In contrast, in the above configuration, the vehicle dispatch supporting section can more accurately determine whether or not a driver can finish both of traveling and taking the rest, in consideration of the peak of the drowsiness level and the time at which the peak comes, the peak being estimated to come to the driver in a predetermined period of time. Therefore, even in a case where the required travel time and the required rest time are short, a driver whose rest will not finish in time for the demand time can be prevented from being assigned to the demand spot.

(Supplementary Note 6)

The vehicle dispatch device according to any one of Supplementary notes 1 to 5, wherein:

the demand information obtaining section obtains, together with the demand time, the demand spot including a plurality of demand spots at each of which the demand time comes within a predetermined period of time from the present; and

the vehicle dispatch supporting section carries out, for each of the demand spots, a process for identifying a driver who is capable of finishing both of traveling to the demand spot and taking the rest by the demand time.

In the above configuration, the vehicle dispatch device can identify, for each of a plurality of demand spots, drivers who can be healthy in time for the demand time, the plurality of demand spots having been identified as spots where demand is expected in a predetermined period of time. In other words, it is possible to obtain, for each of the demand spots, an availability-for-vehicle-dispatch determination result. The vehicle dispatch device can appropriately determine, with use of the determination result thus obtained, which driver is to be assigned to which demand spot while ensuring both of safety and efficiency (revenue).

(Supplementary Note 7)

The vehicle dispatch device according to Supplementary note 6, wherein:

the demand information obtaining section further obtains, for each of the demand spots, the number of drivers that matches demand; and

the vehicle dispatch supporting section assigns the driver identified, preferentially to a demand spot for which the number of drivers is relatively larger.

In the above configuration, the vehicle dispatch device can dispatch a limited resource as much as possible, that is, a driver(s) whose health is suitable for driving as many as possible preferentially to a hot area in which revenue is likely to be larger. Therefore, the above configuration can lead to more efficient vehicle dispatch while safety is ensured.

(Supplementary Note 8)

The vehicle dispatch device according to any one of Supplementary notes 1 to 7, wherein

the demand spot is a representative spot of a hot area in which demand for vehicle dispatch is expected in prediction.

(Supplementary Note 9)

The vehicle dispatch device according to Supplementary note 1, further including

an information providing section configured to provide status information to the terminal device, the demand spot and the demand time being a desired ride spot and a desired ride time, respectively, the desired ride spot and the desired ride time having been transmitted from a terminal device of a user who requests vehicle dispatch,

the vehicle dispatch supporting section carrying out, for each of the drivers, determination on whether or not the each of the drivers can finish both of traveling to the desired ride spot and taking the rest by the desired ride time, and

the status information including, for each of the drivers, a result of the determination and the level of the biological condition at the desired ride time.

In the above configuration, the vehicle dispatch supporting section determines, for each of the drivers, whether or not the driver can be at the desired ride spot at the desired ride time in a state in which the level of the biological condition is less than the predetermined threshold value. Then, information on each of the drivers is presented to a user, together with information on whether the driver is a driver who can arrive, in a state suitable for driving, at the desired ride spot by the desired ride time.

This allows the user to choose a desired driver without anxiety while checking whether the health of that driver is suitable for driving.

(Supplementary Note 10)

The vehicle dispatch device according to any one of Supplementary notes 1 to 9, wherein:

the vehicle dispatch supporting section determines the required rest time corresponding to a difference between a peak of the level in the change over time and the predetermined threshold value.

In the above configuration, the required rest time necessary is determined individually in accordance with the level of the biological condition of each of the drivers. This makes it possible to appropriately determine whether the driver is a driver who can finish both of traveling to the demand spot and taking a rest by the demand time.

(Supplementary Note 11)

The vehicle dispatch device according to any one of Supplementary notes 1 to 10, further including

a notification section configured to provide notification of the demand spot, the demand time, and a resting place, to one or more drivers each having been assigned to the demand spot by the vehicle dispatch supporting section,

the vehicle dispatch supporting section being configured to:
set, as the resting place, a present location of each of the one or more drivers in a case where time at which the level of the biological condition is at a peak in the change over time is closer to the present time than to the demand time; and

set, as the resting place, the demand spot in a case where the time at which the level of the biological condition is at the peak in the change over time is closer to the demand time than to the present time.

In the above configuration, the driver is notified of an appropriate resting place for taking a rest in order to make the level of the biological condition less than a predetermined threshold value at the demand time. The resting place is determined by the vehicle dispatch supporting section so as to make timing for taking a rest appropriate. This allows the driver to take a rest according to such notification and to be in a healthy state suitable for driving at the demand spot at the demand time, so that the driver can safely operate in response to demand.

(Supplementary Note 12)

The vehicle dispatch device according to any one of Supplementary notes 1 to 11, wherein

the biological condition obtaining section obtains a change over time of a drowsiness level as the change over time of the biological condition.

The above configuration makes is possible to dispatch, without missing an opportunity, a driver who is sufficiently awake and capable of safely driving to a place where demand is expected.

(Supplementary Note 13)

A method for controlling a vehicle dispatch device including:

a demand information obtaining step of obtaining a demand spot at which demand for vehicle dispatch is expected and demand time at which the demand is expected;

a biological condition obtaining step of obtaining, for each of drivers, a change over time of a biological condition from the present to the demand time; and

a vehicle dispatch supporting step of determining, for each of the drivers, a required rest time necessary for taking a rest in order to make a level of the biological condition less than a predetermined threshold value at the demand time in the change over time, and to identify, from among the drivers, one or more drivers who are capable of finishing both of traveling to the demand spot and taking the rest by the demand time. This method can yield an effect similar to that of Supplementary note 1.

(Supplementary Note 14)

A control program for causing a computer to function as a vehicle dispatch device according to Supplementary note 1, the control program causing the computer to function as the demand information obtaining section, the biological condition obtaining section, and the vehicle dispatch supporting section.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1 vehicle dispatch device
2 demand prediction device
3 in-vehicle system
4 user terminal device
10 control section
11 storage section
21 demand information obtaining section
22 driver information obtaining section (biological condition obtaining section, driver location obtaining section)
23 vehicle dispatch supporting section
24 notification section
25 checking section
26 information providing section
31 past record aggregating section
32 biological information obtaining section
33 estimation section
34 location information obtaining section
35 information outputting section
100, 200 vehicle dispatch system

1. A vehicle dispatch device comprising:
a demand information obtaining section configured to obtain a demand spot at which demand for vehicle dispatch is expected and demand time at which the demand is expected;
a biological condition obtaining section configured to obtain, for each of drivers, a change over time of a biological condition from the present to the demand time; and
a vehicle dispatch supporting section configured to determine, for each of the drivers, a required rest time necessary for taking a rest in order to make a level of the biological condition less than a predetermined threshold value at the demand time in the change over time, and to identify, from among the drivers, one or more drivers who are capable of finishing both of traveling to the demand spot and taking the rest by the demand time.

2. The vehicle dispatch device according to claim 1, wherein the vehicle dispatch supporting section selects, from among the one or more drivers identified, one or more drivers who are to be assigned to the demand spot.

3. The vehicle dispatch device according to claim 2, wherein:
the biological condition obtaining section is configured to obtain, for the one or more drivers having been assigned to the demand spot, the level of the biological condition at a time point which is a predetermined time before the demand time; and
the vehicle dispatch supporting section is configured to cancel assignment of a driver whose level of the biological condition obtained is not less than the predetermined threshold value, from among the one or more drivers having been assigned to the demand spot.

4. The vehicle dispatch device according to claim 1, further comprising
a driver location obtaining section configured to obtain, for each of the drivers, a present location,
the vehicle dispatch supporting section being configured to:
calculate, for each of the drivers, expected arrival time at which each of the drivers arrives at the demand spot, on the basis of the required rest time and a required travel time which is necessary for each of the drivers to travel from the present location to the demand spot; and
identify one or more drivers whose expected arrival time is not later than the demand time, from among the drivers.

5. The vehicle dispatch device according to claim 4, wherein
the vehicle dispatch supporting section is configured to calculate the expected arrival time in consideration of time at which the level of the biological condition is at a peak in a period from the present to the demand time in the change over time.

6. The vehicle dispatch device according to claim 1, wherein:
the demand information obtaining section obtains, together with the demand time, the demand spot including a plurality of demand spots at each of which the demand time comes within a predetermined period of time from the present; and
the vehicle dispatch supporting section carries out, for each of the demand spots, a process for identifying a driver who is capable of finishing both of traveling to the demand spot and taking the rest by the demand time.

7. The vehicle dispatch device according to claim 6, wherein:
the demand information obtaining section further obtains, for each of the demand spots, the number of drivers that matches demand; and
the vehicle dispatch supporting section assigns the driver identified, preferentially to a demand spot for which the number of drivers is relatively larger.

8. The vehicle dispatch device according to claim 1, wherein
the demand spot is a representative spot of a hot area in which demand for vehicle dispatch is expected in prediction.

9. The vehicle dispatch device according to claim 1, further comprising
an information providing section configured to provide status information to the terminal device,
the demand spot and the demand time being a desired ride spot and a desired ride time, respectively, the desired ride spot and the desired ride time having been transmitted from a terminal device of a user who requests vehicle dispatch,
the vehicle dispatch supporting section carrying out, for each of the drivers, determination on whether or not the each of the drivers can finish both of traveling to the desired ride spot and taking the rest by the desired ride time, and
the status information including, for each of the drivers, a result of the determination and the level of the biological condition at the desired ride time.

10. The vehicle dispatch device according to claim 1, wherein:
the vehicle dispatch supporting section determines the required rest time corresponding to a difference between a peak of the level in the change over time and the predetermined threshold value.

11. The vehicle dispatch device according to claim 1, further comprising
a notification section configured to provide notification of the demand spot, the demand time, and a resting place, to one or more drivers each having been assigned to the demand spot by the vehicle dispatch supporting section,
the vehicle dispatch supporting section being configured to:
set, as the resting place, a present location of each of the one or more drivers in a case where time at which the level of the biological condition is at a peak in the change over time is closer to the present time than to the demand time; and
set, as the resting place, the demand spot in a case where the time at which the level of the biological condition is at the peak in the change over time is closer to the demand time than to the present time.

12. The vehicle dispatch device according to claim 1, wherein
the biological condition obtaining section obtains a change over time of a drowsiness level as the change over time of the biological condition.

13. A method for controlling a vehicle dispatch device comprising:
a demand information obtaining step of obtaining a demand spot at which demand for vehicle dispatch is expected and demand time at which the demand is expected;
a biological condition obtaining step of obtaining, for each of drivers, a change over time of a biological condition from the present to the demand time; and
a vehicle dispatch supporting step of determining, for each of the drivers, a required rest time necessary for taking a rest in order to make a level of the biological condition less than a predetermined threshold value at the demand time in the change over time, and to identify, from among the drivers, one or more drivers who are capable of finishing both of traveling to the demand spot and taking the rest by the demand time.

14. A computer-readable storage medium which stores a control program for causing a computer to function as a vehicle dispatch device according to claim 1, the control program causing the computer to function as the demand information obtaining section, the biological condition obtaining section, and the vehicle dispatch supporting section.
